(19) United States
(12) Patent Application Publication
(10) Pub. No.: US 2024/0426866 A1
(43) Pub. Date: Dec. 26, 2024

(54) MULTI-SENSOR FIELD UNIT

(71) Applicant: UPTIME SOLUTIONS, LLC, Jacksonville, FL (US)

(72) Inventors: James W. Girardeau, JR., Austin, TX (US); Taylor Padham, Derry, NH (US)

(21) Appl. No.: 18/211,882

(22) Filed: Jun. 20, 2023

(51) Int. Cl. G01P 15/08; G01P 15/09; G01P 15/18

(52) U.S. Cl. CPC G01P 15/0802; G01P 15/09; G01P 15/18

(57) ABSTRACT

A multi-sensor field unit is used to monitor one or more machine parameters of at least one machine or machine component and wirelessly transmit data based on readings taken by sensors of the multi-sensor field unit to an application or to a remote device such as a base station. To reduce the amount of data that is stored at the multi-sensor field unit and that is wirelessly transmitted by the multi-sensor field unit, the multi-sensor field unit includes a controller to modulate sampling parameters of the sensors based on a priority protocol and a power budget.

### BACKGROUND

Industrial facilities, such as manufacturing facilities, laboratories, research facilities, refineries, other structures, and the like, often use sensors to monitor machine parameters. For example, sensors may be used to measure machine parameters such as vibration, acceleration, velocity, sound, electric field, speed, torque, displacement, and the like. Each sensor produces an analog output voltage, current, or digital representation of the machine parameter being measured. In many cases, a field unit samples the signal output by a sensor and transmits data representing the sampled signal over a wireless network to a remote device such as a base unit. Field units are often battery powered and have limited bandwidth for transmitting the data representing signals produced by the sensors monitoring the machine parameters. Consequently, transmission of the data often taxes the wireless network and limits the operational time of the field units on a given battery charge.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram illustrating a sampling system including a multi-sensor field unit in accordance with some embodiments.

FIG. 2 is a block diagram illustrating a controller of a multi-sensor field unit modulating sampling parameters of sensors based on a priority protocol and a power budget in accordance with some embodiments.

FIG. 3 is a block diagram illustrating sampling parameters of a multi-sensor field unit in accordance with some embodiments.

FIG. 4 is a flow diagram illustrating a method of modulating sampling parameters of multiple sensors of a field unit based on a priority protocol and a power budget in accordance with some embodiments.

### DETAILED DESCRIPTION

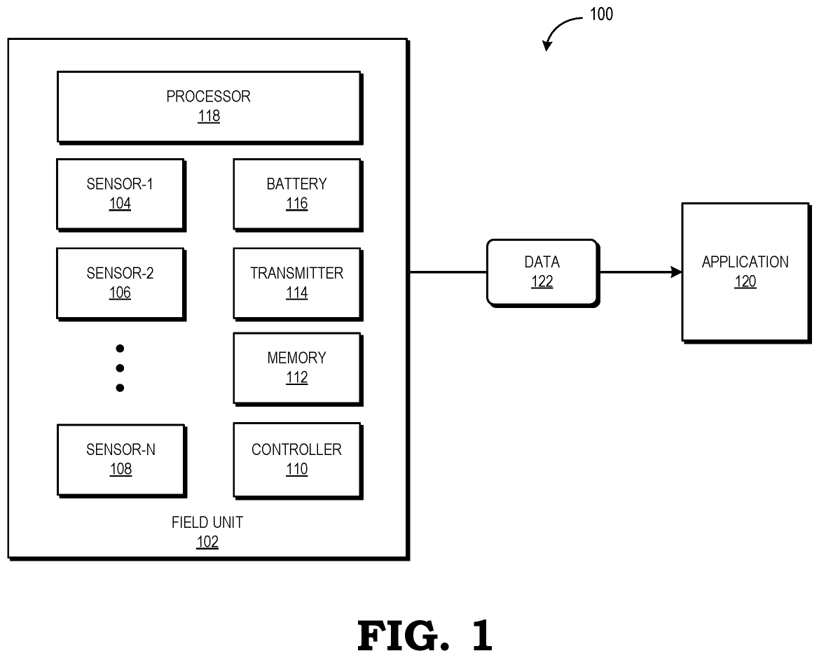

FIGS. 1-4 illustrate example implementations of a multi-sensor field unit that modulates sampling parameters of sensors based on a priority protocol and a power budget in accordance with some embodiments. The multi-sensor field unit is used to monitor one or more machine parameters of at least one machine or machine component and wirelessly transmit data based on readings taken by sensors of the multi-sensor field unit to an application or to a remote device such as a base station. The machine parameters may include relatively slowly varying characteristics such as humidity, temperature, fluid flow rate, pressure, liquid level, gas concentration, loudness, strain, voltage, current, and resistance, as well as relatively quickly varying characteristics such as sound, acceleration, linear velocity, angular velocity, displacement, voltage, current, flow, pressure, and force.

As used herein, the term “machine” refers to a structure or combination of structures subject to environmental changes or mechanical forces, either self-generated or externally applied. Structures with self-generated mechanical forces include, for example boilers, compressors, generators, transformers, industrial robots, rotating bearings, mills, lathes, grinders, saws, welders, ovens, mining equipment, and the like. Structures with externally applied mechanical forces include, for example, bridges and other spans, buildings, cranes, boat hulls, highways, and the like. Moreover, it will be appreciated that some machines may comprise structures subject to both self-generated mechanical forces and externally-applied mechanical forces.

In some embodiments, the multi-sensor field unit includes sensors of different types that are adapted to monitor either relatively slowly varying characteristics or relatively quickly varying characteristics of a machine or machine component. For example, in some embodiments, the multi-sensor field unit includes at least one sensor adapted to monitor relatively slowly varying characteristics of a machine or machine component that, when sampled, returns a single value. The multi-sensor field unit also includes, in some embodiments, at least one sensor adapted to monitor relatively quickly varying characteristics of a machine or machine component that, when sampled, returns a set of values sampled at intervals of e.g., 1 Hz to 160 KHz. In some embodiments, the multi-sensor field unit condenses data from a returned set of values, both to allow trends in sample readings to be more cleanly observed and to consolidate information for subsequent analysis. Data consolidation further reduces the amount of power used to store data at the multi-sensor field unit and to transmit data from the multi-sensor field unit to a remote device or application.

To reduce the amount of data that is stored at the multi-sensor field unit and that is wirelessly transmitted by the multi-sensor field unit, the multi-sensor field unit includes a controller to selectively modulate sampling parameters of the sensors based on a priority protocol and a power budget. In some embodiments, the sampling parameters include whether a sensor is active, the sampling interval, the quantity of data taken in each sample, whether and how the data are condensed, and the sampling rate. In some embodiments, sampling parameters for a given sensor are further based on sensor attributes such as frequency, fidelity, signal level, power usage, thermal stability, ramp time, repeatability, range, span, accuracy, precision, resolution, linearity, sensitivity, signal-to-noise ratio, phase shift, additional circuitry required to condition a signal for sampling, and sensor physical or mechanical attributes.

The priority protocol indicates an importance of obtaining sensor readings of a given type at a given frequency based on at least one of an age of a machine component from which the field unit takes readings, accessibility of the field unit on the machine component, criticality of the machine component, and expense of the machine component in some embodiments. For example, as a machine or machine component ages, more frequent sampling may be implemented to detect changes in the behavior of the machine or machine component before the changes result in deterioration of performance. As another example, if the multi-sensor field unit is difficult to access based on its location on a machine or within a facility, the priority protocol may indicate that sampling parameters should be modulated to more aggressively conserve battery power in some embodiments. If the machine or machine component being monitored is critical to production flow at a facility or if the cost of repairing the machine or machine component is high, the priority protocol may indicate that more frequent or more sensitive sampling should be implemented.

The power budget indicates an amount of remaining battery life of the multi-sensor field unit, memory bandwidth of the multi-sensor field unit, and transmission bandwidth (e.g., energy available to transmit data over a radio frequency interface) of the transmitter of the multi-sensor field unit. The controller modulates sampling parameters of one or more of the sensors of the multi-sensor field unit based at least in part on the power budget in some embodiments. For example, if the power budget indicates that remaining battery power, memory bandwidth, or transmission bandwidth are limited, the controller modulates sampling parameters of one or more of the sensors to conserve power by, e.g., sampling less frequently with a more sensitive sensor that consumes more power and sampling more frequently with a less sensitive sensor that consumes less power, or condensing data returned by one or more sensors to conserve memory or transmission bandwidth.

In some embodiments, the controller modulates sampling parameters of one or more sensors in response to detection of a fault condition. For example, in a multi-sensor field unit having a less sensitive sensor, such as a microelectromechanical system (MEMS) sensor, and a more sensitive sensor, such as a piezoelectric sensor, the controller may initially activate the less sensitive sensor while leaving the more sensitive sensor in an inactive state to conserve power. In some embodiments, in response to detecting a fault condition based on readings taken by the less sensitive sensor, the controller initiates sampling (i.e., activates) the more sensitive sensor to facilitate a diagnosis of the fault condition.

FIG. 1 illustrates a sensing system 100 including a multi-sensor field unit (referred to herein as a field unit 102) and an application 120. The field unit 102 includes a plurality of sensors (sensor-1 104, sensor-2 106, . . . , sensor-N 108), a controller 110, a memory 112, a transmitter 114, a battery 116, and a processor 118. The field unit 102 collects readings from the plurality of sensors of machine parameters and transmits data 122 based on the readings to the application 120 or, in some embodiments, to a remote device (not shown) such as a base station. The machine parameters may indicate, for example, that a machine is on, off, sleeping, paused, normal, near failure, healthy, unhealthy, broken, partially functioning, performing below standard, performing above standard, malfunctioning, in need of maintenance, in need of calibration, etc.

For example, vibration in a machine may indicate imbalances, meshing of gear teeth, uneven friction, worn out or failing components, or the like, and may result in unwanted noise, wasted energy, increased wear, machine or part failure, or the like. As such, it is advantageous to identify and remedy the cause of vibrations early. Generally, early signs of unwanted vibrations are much more subtle, having higher frequencies and lower amplitudes than when the vibration is allowed to continue. As such, the higher the frequency that a given sensor of the field unit 102 is able to sense, the better chance of identifying early signs of vibration in the machine. For example, accelerometers are only able to sense frequencies lower than the resonance frequency of the accelerometer. The resonance frequency is the frequency at which the accelerometer resonates or rings; that is, the point in frequency within an accelerometer's frequency response where maximum sensitivity is outputted. Thus, including in the field unit 102 multiple sensors 104, 106, 108 of different types that have different frequency responses, that measure different aspects of a machine's parameters, and/or that consume different amounts of power allows the field unit 102 to more comprehensively monitor the health and performance of a machine or machine component while balancing priorities with available power and bandwidth.

The field unit 102 transmits the data 122 to the application 120 over a wireless network (not shown) via the transmitter 114 at the field unit 102. In at least one embodiment, the transmitter 114 includes a wireless transceiver, such that the application 120 may also transmit information over the wireless network to the field unit 102. In at least one embodiment, the transmitter 114 is housed within the field unit 102. Any of a variety of radio technologies may be implemented by the transmitter 114, such as an IEEE 802.11x (WiFi)-based technology, 900 megahertz (MHz), 434 MHz, or 2.4 gigahertz (GHz) technology, a Global System for Mobile Communications (GSM) technology, a General Packet Radio Service (GPRS) technology, and the like.

In some embodiments the controller 110 implements settings that sample the sensors 104, 106, 108 at predetermined intervals, at predetermined times, between predetermined hours, at random, or a combination of these. When sampled, each sensor 104, 106, 108 returns a timestamp of when the sample set was taken, a set of values (which in some embodiments includes a single value) and, for sets including more than one value (referred to herein as a waveform signal), an interval between the values in the set of values. In some embodiments, the interval between values is constant, and in other embodiments, the intervals between values are variable.

Sensors that return waveform signals have varying degrees of accuracy. Sensors having higher accuracy, such as piezoelectric accelerometers, can be considered “high-fidelity” type sensors. Conversely, sensors having lower accuracy, such as MEMS accelerometers, can be considered “low-fidelity” type sensors. Low-fidelity and high-fidelity sensors can be considered different types of sensors, even if each measures the same machine parameter. For example, a piezoelectric sensor may have a higher frequency range, maximum amplitude, power consumption, and cost than a MEMS sensor, while a MEMS sensor has a higher noise floor than a piezoelectric sensor in some embodiments. In general, piezoelectric sensors provide more accurate readings compared to MEMS sensors, but have a higher power consumption due to associated electronics used to read the sensor, whereas MEMS sensors are typically highly integrated and can operate at significantly lower power points. Such disparities result in tradeoffs between power consumption, expense of a sensor, and quality of data when selecting between different types of sensors (e.g., piezoelectric vs. MEMS sensors) for a given application.

Each of the sensors 104, 106, 108 may comprise, for example, an accelerometer, a thermometer, a thermocouple, a fluid flow rate sensor, a gas detector, a level detector, a velocity probe, a displacement probe, a pressure sensor, a sound level meter, an ultrasonic sensor, a humidity probe, a corrosion strip, a load cell, a resistance temperature detector (RTD), a proximity sensor, a tachometer, a voice band sensor, a strain sensor, a photodetector, a voltmeter, an ammeter, a multimeter, an ohmmeter, a combination of these, and any other type of sensor. Each type of sensor can vary in form and output, and a typical sensor produces an analog output voltage, a current, or a digital representation of the parameter being measured. Each type of sensor also has a representative set of output characteristics such as frequency range, voltage range, current range, temperature, impedance, a combination of these, or other electrical mechanical, or physical properties. Each sensor 104, 106, 108 is located at or near one or more machines, machine components, areas, or parts to detect machine parameters. In some embodiments, a single sensor can sense multiple parameters.

The processor 118 serves as an analyzer for the sensors 104, 106, 108, by processing and converting the analog or other signals received from the sensors 104, 106, 108 into a digital representation of the sensor data. The processing steps may include low-pass filtering, high-pass filtering, band-pass filtering, gain adjustment, nonlinear adjustments, noise mitigation, zero crossing detection, level detection, analog to digital conversion, or other types of linear or nonlinear processing steps. Non-linear adjustments may include distortion correction, limiting, or rectification. It will be apparent to those skilled in the art that there are many possible processing steps and many ways to obtain digital data from analog data. In some embodiments, the processor 118 may comprise extensive analysis capabilities, and can apply various time domain filters and analysis steps. Frequency domain analysis is also available in some embodiments of the processor 118, whereby the processed time domain signal can be viewed in the frequency domain, allowing analysis of frequency dependent data. Multiple sensor outputs can be collected coherently by the processor 118 to produce multi-dimensional plots or to perform multi-dimensional analysis.

Some embodiments of the memory 112 are implemented as a dynamic random-access memory (DRAM). However, the memory 112 can also be implemented using other types of memory including static random-access memory (SRAM), nonvolatile RAM, and the like. In the illustrated embodiment, the processor 118 communicates with the memory 112 over a bus (not shown). However, some embodiments of the processor 118 communicate with the memory 112 over a direct connection or via other buses, bridges, switches, routers, and the like. The processor 118 executes instructions stored in the memory 112 and the processor 118 stores information in the memory 112 such as the results of the executed instructions. For example, the memory 112 can store a copy of instructions from the application 120 that is to be executed by the processor 118. The memory 112 is sized to store a limited amount of data and instructions. The amount of available storage at the memory 112 is referred to herein as the memory bandwidth.

To conserve the memory bandwidth, the controller 110 modulates the sampling parameters and signals the processor 118 to indicate whether and to what extent the sensor readings are to be condensed. For example, in some embodiments in which a sensor reading is in the form of a waveform, the controller 110 may indicate that the processor 118 is to condense the sensor reading to a root-mean-square (RMS) value of the waveform to indicate the average energy present in the waveform. In other embodiments, the controller 110 may indicate that the processor 118 is to condense the sensor reading to a true peak, indicating the amplitude of a point in the waveform which is largest in magnitude. In some embodiments, the controller 110 may indicate that the processor 118 is to condense the sensor reading to a derived peak, which is an approximation of the furthest variation of the signal away from the mean, obtained by scaling the RMS value by a factor of sqrt (2). In other embodiments, the controller 110 may indicate that the processor 118 is to condense the sensor reading to a crest factor, which is obtained by calculating the ratio of the true peak to the RMS to characterize one aspect of the shape of the waveform. In some embodiments, the controller 110 indicates that the processor 118 is to condense the sensor reading into an array of two or more single point parameters such as the RMS, the true peak, the derived peak, and the crest factor of the waveform.

In some embodiments, the controller 110 indicates that the processor 118 is to transform a waveform reading into a frequency representation by taking a fast Fourier transform (FFT) of the waveform. The frequency representation can also be condensed into parameters such as RMS energy, band energy (i.e., energy between a first frequency and a second frequency), machine specific energy bands, and harmonic energy bands.

In some embodiments in which one or more of the sensors 104, 106, 108 is a tachometer, which provides a waveform signal indicating how fast the object under observation is rotating, the controller 110 signals the processor 118 to conduct post-processing of the waveform signal to derive the speed at which the object under observation is rotating (referred to herein as the running speed). Based on the running speed, the controller 110 may instruct the processor 118 to derive further information from the waveform signal, such as energy present in the spectrum at frequencies below that of the running speed (referred to as sub-synchronous energy), energy that is present in the spectrum at frequencies associated with the running speed and its harmonics (referred to as synchronous energy), energy outside the bounds of the running speed and its harmonics (non-synchronous energy), and/or energy present at frequencies which are multiples of the running speed (harmonic energy). In some embodiments, the condensed parameters are generated from one or both of the waveform and spectrum for a single sample.

The battery 116 provides power to the field unit 102. In some embodiments, the battery contains a super capacitor or other short term energy device. To conserve the limited lifespan of the battery 116, the controller 110 modulates the sampling parameters of the sensors 104, 106, 108 to meet operational objectives while limiting power usage.

In operation, the controller 110 sets initial sampling parameters for each of the sensors 104, 106, 108 based on an initial priority protocol and an initial power budget. For example, in some embodiments, sensor-1 104 is a MEMS accelerometer and sensor-2 106 is a piezoelectric accelerometer. The initial sampling parameters are for the sensor-1 104 to take N samples per sampling interval and sets the sensor-2 106 to take zero samples per sampling interval in the example. In response to an event such as a reading from sensor-1 104 exceeding a predetermined threshold, in some embodiments, the controller 110 modulates the sampling parameters by, for example, reducing the number of samples per sampling interval taken by sensor-1 104 and phasing in sampling by sensor-2 106. Thus, a condition detected by the MEMS accelerometer triggers sampling by the piezoelectric accelerometer. By initially relying on the lower power MEMS accelerometer and only activating sampling by the piezoelectric accelerometer when the reading from the MEMS accelerometer exceeds the threshold, the controller 110 conserves battery life while maintaining accuracy in sensing.

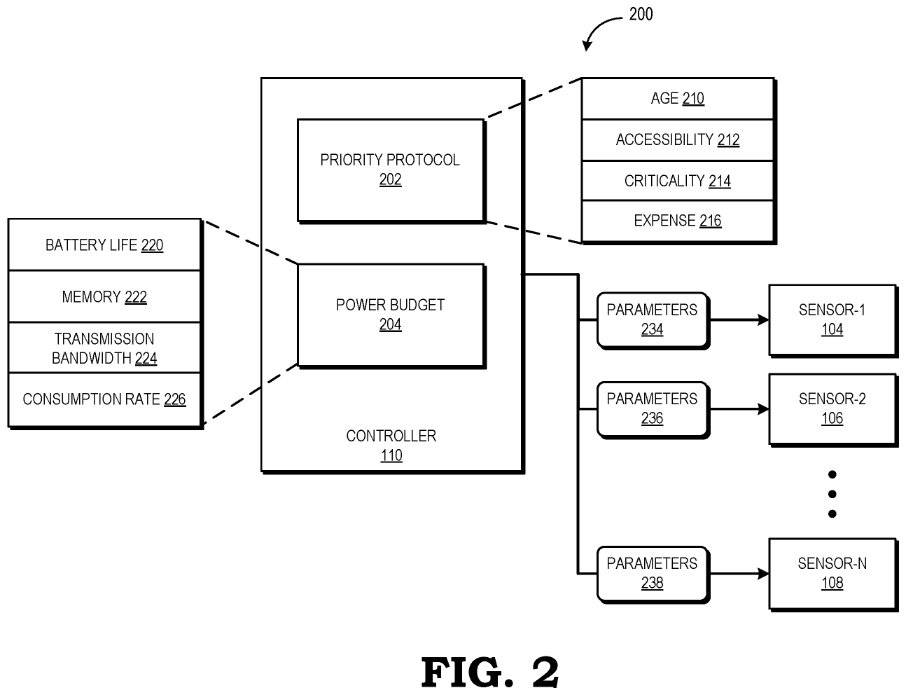

FIG. 2 is a block diagram 200 illustrating the controller 110 of the field unit 102 modulating sampling parameters of sensors based on a priority protocol 202 and a power budget 204 in accordance with some embodiments. In the illustrated example, the priority protocol 202 is based on the age 210 of the machine or machine component being monitored, the accessibility 212 of the field unit 102, the criticality 214 of the machine or machine component being monitored, and the expense 216 of repairing or replacing the machine or machine component being monitored. In some cases, the priority protocol 202 specifies more frequent sampling for an older machine or machine component (i.e., that is nearing the end of its expected lifespan) than for a newer machine. In instances where the field unit 102 is difficult to access, the priority protocol 202 may specify a different subset of sensors and/or parameters or less frequent sampling to conserve the life of the battery 116. If the machine or machine component being monitored is critical to production flow and has low redundancy, the priority protocol 202 may specify more frequent sampling by a more sensitive sensor to ensure that any fault conditions are detected early.

In the illustrated example, the power budget 204 is based on the remaining battery life 220 of the battery 116, the available memory bandwidth 222 of the memory 112, the transmission bandwidth 224 of the transmitter 114, and a consumption rate 226 of resources (e.g., battery life 220, memory bandwidth 222, and transmission bandwidth 224) of the field unit 102 at current settings for the sampling parameters. The controller 110 considers the availability of resources and the consumption rate of the resources in determining the power budget 204 for selectively modulating sampling parameters of the sensors 104, 106, 108.

The controller 110 applies an initial set of sampling parameters for each of the sensors 104, 106, 108 based on, e.g., a priority protocol and a power budget. In some embodiments, the initial sampling parameters are indicated by the application 120. In some embodiments, the controller 110 subsequently modulates the initial set of sampling parameters for each of the sensors 104, 106, 108 individually in some embodiments. For example, in the illustrated embodiment, the controller 110 modulates sampling parameters 234 for sensor-1 104, sampling parameters 236 for sensor-2 106, and sampling parameters 238 for sensor-N 108. The controller 110 adjusts the sampling parameters 234, 236, 238 in response to an event (such as a detected fault or a reading exceeding a threshold value) in some embodiments, or periodically, based on a reassessment of the priority protocol 202 and the power budget 204 according to a predetermined interval in other embodiments. In some embodiments including one or more arrays of sets of sensors, the controller 110 modulates sampling parameters for each of set of sensors of a plurality of sets of sensors.

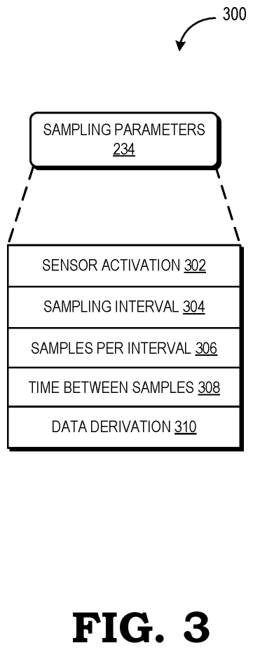

FIG. 3 is a block diagram 300 illustrating sampling parameters 234 of a multi-sensor field unit in accordance with some embodiments. In the illustrated example, the sampling parameters 234 include sensor activation 302, sampling interval 304, a number of samples per sampling interval 306, a time between samples within a sampling interval 308 (i.e, sampling rate), and data derivation 310. Sensor activation 302 indicates whether the subject sensor is active or inactive for the current sampling period. The sampling period refers to the period of time for which current sampling parameters 234 are in effect (i.e., until the next event or scheduled reassessment of the priority protocol 202 and power budget 204).

The sampling interval 304 indicates how frequently the subject sensor is to take readings (i.e., collect data) for each sample set. For example, in some embodiments the sampling interval 304 for a subject sensor is once per minute, once per hour, once per day, etc. For slowly changing machine parameters, the controller 110 may set a longer sampling interval 304, and for faster changing machine parameters, the controller 110 may set a shorter sampling interval 304. The sampling interval 304 is set based on the time of day or other factors such as whether the machine or machine component is known to be running in some embodiments.

In some embodiments, the sampling interval 304 is based on how soon a failure of the measured machine or machine component is anticipated. For example, if a bearing is being monitored by the sensor 104 of the field unit 102 and it is known based on past readings that a failure is not expected for at least one week, the controller 110 may set an initial sampling interval 304 of once per day, which should provide ample advance notice of an impending failure of the bearing. If the once-daily measurements of the vibration frequency and surface temperature of the bearing indicate that the bearing could fail within two days, the controller 110 may shorten the sampling interval 304 to, e.g., six hours.

The number of samples per sampling interval 306 indicates the number of discrete points in a reading. For sensors that measure more static machine parameters, such as temperature, the controller 110 may set the number of samples per sampling interval 306 to one. For sensors that measure frequency selective machine parameters, the controller 110 may set the number of samples per sampling interval 306 to a higher number, such as 256 samples to 32,768 samples per sampling interval. In some embodiments, the samples are taken in a burst within the sampling interval 304. In other embodiments, the samples are taken at uniformly distributed times within the sampling interval 304. In some embodiments, the time between samples within a sampling interval 304 is variable.

In some embodiments the number of samples per sampling interval 306 is based on a target or desired accuracy. For example, an FFT resolution accuracy (or the accuracy of other methods of determining frequency) is proportional to the number of samples upon which it is based. A higher number of samples per sampling interval 306 provides more information, but at the expense of using more power, more of the memory 112 and higher transmission bandwidth 224 of the transmitter 114. In some embodiments, a lower accuracy is targeted earlier in the lifecycle of a machine or machine component and a higher accuracy is targeted later in the lifecycle. In some embodiments, by setting the number of samples per sampling interval 306 to zero, the controller 110 effectively sets the sensor activation 302 to inactive for the current sampling period.

The time between samples within a sampling interval 308 is based on the Nyquist sampling theory in some embodiments. For example, if a sensor is measuring a bearing vibration frequency and the highest frequency of interest is 10 Hz, the controller may set the initial time between samples within a sampling interval 308 to no more than 1/20 Hz. In some embodiments, the controller 110 sets the time between samples within a sampling interval 308 to take data at least 2.56 times the highest frequency of interest to account for non-idealities in the system, such that for a 10 Hz frequency of interest, the controller 110 sets the sensor to take data at least every 1/25.6 Hz time interval.

Data derivation 310 indicates whether and to what extent the sensor readings are to be distilled into a reduced subset of values. For example, the controller 110 may indicate that the processor 118 is to condense the sensor reading to a root-mean-square (RMS) value of the waveform, to a true peak, to a derived peak, and/or to a crest factor. In some embodiments, the controller 110 indicates that the processor 118 is to take a FFT (or other analysis method) of the waveform or that the frequency representation is to be condensed into parameters such as RMS energy, band energy, machine specific energy bands, and harmonic energy bands. In some embodiments, the controller 110 signals the processor 118 to conduct post-processing of the waveform signal to derive the running speed of the object under observation as well as other parameters such as sub-synchronous energy synchronous energy, non-synchronous energy, and/or harmonic energy. Data derivation 310 reduces the amount of memory 112 required to store data collected by the sensors 104, 106, 108 as well as the transmission bandwidth 224 needed to transmit the data 122 to the application 120.

In some embodiments, the controller 110 initializes the field unit 102 by establishing a baseline, or record of state, for each sensing location to determine the health status and progression of faults in a system or sampling environment (e.g., a machine or machine component). The controller 110 stores metrics regarding the baseline at the memory 112 and uses the metrics to detect and quantify deviations from the baseline that may indicate the health status of the machine or machine component at the sensing location at a given point in time. In some embodiments, the controller 110 establishes the baseline by signaling the sensors 104, 106, 108 to take N samples at the highest fidelity with predetermined data derivation 310 to post-process the samples. The controller 110 generates a summary of the condition of the machine or machine component in some embodiments, such as no issues detected, moderate issues detected, or severe issues detected. The baseline metrics stored at the memory 112 include averaged waveform and/or, for a given parameter measurement, the number of data points, median, mean, mode, and standard deviation in some embodiments.

In an example, the controller 110 initially sets sampling parameters for a low-fidelity sensor to take N samples per sampling interval and sets sampling parameters for a high-fidelity sensor to take zero samples per sampling interval. In response to detecting a fault condition (e.g., a bearing frequency exceeding a predetermined threshold) based on readings from the low-fidelity sensor, the controller 110 modulates the sampling parameters for the low-fidelity sensor to take (N-M) samples per sampling interval and modulates the sampling parameters for the high-fidelity sensor to take M samples per sampling interval to better analyze the machine parameters.

In some embodiments, the controller 110 adjusts the sampling parameters of the low-fidelity sensor and the high-fidelity sensor as the health of the machine degrades. For example, the controller 110 may set the low-fidelity sensor to take all readings until the machine health degrades past a threshold, at which point the controller 110 switches to the high-fidelity sensor for every Nth sampling interval, where N starts as a large number and eventually converges to 1, such that every sample will be taken by the high-fidelity sensor. By phasing in sampling by the high-fidelity sensor and phasing out sampling by the low-fidelity sensor as the machine's health degrades, the controller 110 conserves the battery life 220 during most of the machine's operational time and only slowly switches to the higher power consuming high-fidelity sensor to take high-fidelity readings more often as the machine's health starts to degrade. In some embodiments, the controller 110 initially sets the sampling parameters of the high-fidelity sensor to take at least some readings at all times (e.g., to take a high-fidelity reading once per week) to ensure that looming faults that are below the detectability threshold of the low-fidelity sensor are detected early while optimizing system efficiency such as power and bandwidth. In some embodiments, the controller 110 alternates sampling between sensors of different types that have similar fidelities.

By multiplexing sampling by different sensor types over time, the controller 110 increases the probability of detecting faults early. In the life cycle of a machine, the first sign of faults are typically subtle changes in high frequency ultrasonic sound, which are detectable using ultrasonic sensors that measure high frequency sound (e.g., approximately 40 KHz). Subsequent vibration by the machine is detectable by high quality accelerometers, which measure vibration. Piezoelectric accelerometers typically measure vibrations up to approximately 20 KHz, and MEMS accelerometers typically measure vibrations of up to approximately 6 KHz to 8 KHz. Thus, in some embodiments, the controller 110 sets initial sampling parameters such that an ultrasonic sensor takes a high proportion of samples and an accelerometer takes a smaller proportion of sample. Over time and as machine failure becomes more apparent, the controller 110 modulates the sampling parameters of the sensors to include sampling by other sensor types until only the applicable sensor (e.g., a high-fidelity sensor) is actively sampling. The controller 110 thus balances the priority protocol 202 with the power budget 204 as conditions change over time to save power while optimizing the sampling of the machine or machine component.

In some embodiments, the controller 110 sets initial sampling parameters for N sensors of the field unit 102 using the following formula:

$$Sample\_set = T 1 of sensor - 1 \; 104 , T 2 of sensor - 2 \; 106 , … , T 3 of sensor - N 108 ,$$

where Tx is the proportion of samples taken by the field unit 102 within a sampling period that are to be taken by the corresponding sensor and 0≤ x≤1, such that

$$T 1 + T 2 + ⋯T3 = 1 .$$

Thus, T1=0 indicates that the sensor-1 104 is to take no samples in the sampling period and T2=1 indicates that sensor-2 106 is to take all samples taken by the field unit 102 in the sampling period. In an example, sensor-1 104 is a MEMS accelerometer and sensor-2 106 is a piezoelectric accelerometer. The controller 110 sets initial sampling parameters of T1=1 and T2=0. The controller 110 reassesses the sampling parameters after each sampling period (which in some cases is after each reading). In some embodiments, the controller 110 applies a priority protocol 202 such that if overall vibration exceeds X grms, then modulate the sampling parameters to T1=0.75 and T2=0.25, if overall vibration exceeds Y grms, then modulate the sampling parameters to T1=0.25 and T2=0.75, and if overall vibration exceeds Z grms, then modulate the sampling parameters to T1=0 and T2=1. In other embodiments, sensor-1 104 and sensor-2 106 are any type of sensor and are not limited to the above example of a MEMS accelerometer and a piezoelectric accelerometer.

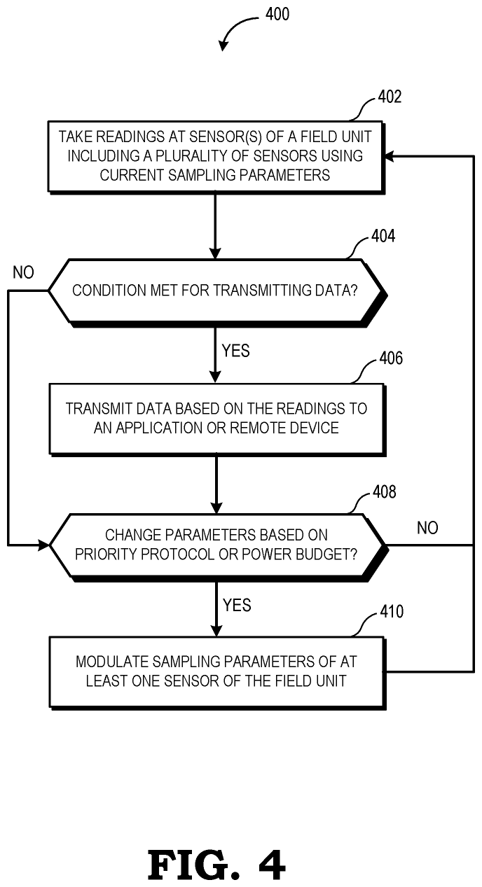

FIG. 4 is a flow diagram illustrating a method 400 of modulating sampling parameters of multiple sensors of a field unit based on a priority protocol and a power budget in accordance with some embodiments. At block 402, the controller 110 sets current sampling parameters based on a current priority protocol 202 and power budget 204 which are used by the sensors 104, 106, 108 to take readings of a machine or machine component. In some embodiments, the current sampling parameters are predetermined or are indicated by the application 120. In some embodiments, the current sampling parameters are based on a baseline established by initialization of the field unit 102. At block 404, the controller 110 determines whether a condition has been met for transmitting data 122 based on the readings to the application 120 or to a remote device. In some embodiments, the condition is whether a reading was taken (i.e., all readings are transmitted). In other embodiments, the condition is one or more readings exceeding a threshold. If, at block 404, the controller 110 determines that the condition has been met, the method flow continues to block 406. If, at block 404, the controller determines that the condition has not been met, the method flow continues to block 408. At block 406, the transmitter 114 selectively transmits data 122 based on the readings to the application 120 or to a remote device.

At block 408, the controller determines whether to change the sampling parameters of one or more of the sensors 104, 106, 108 based on the priority protocol 202 and the power budget 204 in response to an event (such as a detected fault or above threshold reading), in response to an indication from the application 120, or at the next sampling period. If, at block 408, the controller 110 determines that the sampling parameters of one or more of the sensors 104, 106, 108 do not need to be changed, the method flow returns to block 402. If, at block 408, the controller 110 determines that the sampling parameters of one or more of the sensors 104, 106, 108 should be changed based on the priority protocol 202 and the power budget 204, the method flow continues to block 410.

At block 410, the controller 110 modulates the sampling parameters of one or more of the sensors 104, 106, 108 based on the priority protocol 202 and the power budget 204. In some embodiments, the controller 110 uses statistical analysis of sensor readings and/or machine learning algorithms to determine whether and how to modulate the sampling parameters. The method flow then continues back to block 402.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A field unit, comprising:
a plurality of sensors to take readings from one or more components of a machine;
a transmitter to selectively transmit data based on readings from the plurality of sensors to a remote device or an application; and
a controller to set sampling parameters of at least one sensor of the plurality of sensors based on a priority protocol and a power budget.

2. The field unit of claim 1, wherein a first sensor of the plurality of sensors is a microelectromechanical system (MEMS) sensor and a second sensor of the plurality of sensors is a piezoelectric sensor.

3. The field unit of claim 1, wherein the power budget is based on at least one of remaining battery life of the field unit, a memory bandwidth of the field unit, power consumption of the plurality of sensors, and a transmission bandwidth of the transmitter.

4. The field unit of claim 1, wherein the priority protocol is based on at least one of:
an age of a machine component from which the field unit takes readings;
accessibility of the field unit on the machine component;
criticality of the machine component; and
expense of the machine component.

5. The field unit of claim 1, wherein the controller is to modulate the sampling parameters of at least one sensor of the plurality of sensors in response to an indication from the application or one or more readings exceeding a threshold value.

6. The field unit of claim 5, wherein the controller is to initiate sampling by a first sensor of the plurality of sensors based on readings taken by a second sensor of the plurality of sensors.

7. A field unit, comprising:
a first sensor of a first type;
a second sensor of a second type different from the first type;
a transmitter to transmit data based on readings from the first sensor and the second sensor to a remote device or an application; and
a controller to selectively modulate sampling by the first sensor and the second sensor based on a priority protocol and a power budget.

8. The field unit of claim 7, wherein the first type is configured to take readings at a first sampling interval and a first sampling rate and the second type is configured to take readings at a second sampling interval and a second sampling rate.

9. The field unit of claim 8, wherein the first type comprises a microelectromechanical system (MEMS) sensor and the second type comprises one of an ultrasonic sensor and a piezoelectric sensor.

10. The field unit of claim 7, wherein the power budget is based on at least one of remaining battery life of the field unit, a memory bandwidth of the field unit, and a transmission bandwidth of the transmitter.

11. The field unit of claim 7, wherein the priority protocol is based on at least one of:
an age of a machine component from which the field unit takes readings;
accessibility of the field unit on the machine component;
criticality of the machine component; and
expense of the machine component.

12. The field unit of claim 7, wherein the controller is to modulate sampling by at least one of the first sensor and the second sensor in response to an indication from the application or one or more readings exceeding a threshold value.

13. The field unit of claim 12, wherein the controller is to initiate sampling by the second sensor based on readings taken by the first sensor.

14. A method, comprising:
taking readings of a machine component at a first sensor of a field unit comprising a plurality of sensors;
selectively transmitting, at a transmitter, data based on readings from the first sensor to a remote device or application; and
selectively modulating sampling parameters of at least one of the first sensor and a second sensor of the plurality of sensors based on a priority protocol and a power budget.

15. The method of claim 14, wherein selectively modulating the sampling parameters comprises taking readings at the first sensor at a first sampling interval and a first sampling rate and taking readings at the second sensor at a second sampling interval and a second sampling rate.

16. The method of claim 15, wherein the first sensor comprises a microelectromechanical system (MEMS) sensor and the second sensor comprises one of an ultrasonic sensor and a piezoelectric sensor.

17. The method of claim 14, wherein the power budget is based on at least one of remaining battery life of the field unit, a memory bandwidth of the field unit, and a transmission bandwidth of the transmitter.

18. The method of claim 14, wherein the priority protocol is based on at least one of:
an age of a machine component from which the field unit takes readings;
accessibility of the field unit on the machine component;
criticality of the machine component; and
expense of the machine component.

19. The method of claim 14, wherein modulating sampling by at least one of the first sensor and the second sensor is in response to an indication from the application or one or more readings exceeding a threshold value.

20. The method of claim 19, further comprising:
initiating sampling by the second sensor based on readings taken by the first sensor.
